(19) United States
(12) Patent Application Publication
(10) Pub. No.: US 2009/0265607 A1
(43) Pub. Date: Oct. 22, 2009

(54) Method, system and computer readable product for management, personalization and sharing of web content

(75) Inventors: Rami Raz, Holon (IL); Gali Ross, Tel Aviv (IL)

Correspondence Address: Ronny Fogel;c/o Daltan Consulting Ltd., P.O. Box 1146, Kfar Sava, 44110, IL

(73) Assignee: Razoss Ltd., Ramat Gan (IL)

(21) Appl. No.: 12/385,687

(22) Filed: Apr. 16, 2009

Related U.S. Application Data
(60) Provisional application No. 61/045,639, filed on Apr. 17, 2008.

(51) Int. Cl. G06F 17/00; G06F 3/00; G06F 15/16

(52) U.S. Cl. 715/233; 715/230; 715/751; 709/217; 715/760; 715/234

(57) ABSTRACT

A computerized system and method for managing, annotating and sharing web pages comprising: a system server comprising a server application and a www server, the system server communicating over the internet with one or more client computers, each S comprising a www browser and a client application, the system server storing, for each the client computers, a plurality of web-project folders, each web-project comprising links to web-pages accessed by the client computer's user and annotations added by the user to the web-pages, the server application comprising means for managing the stored data, each client application comprising means for viewing the stored server data; means for managing the stored server data; means for selecting a web project; means for selecting a web-page for display; means for selecting an annotation for display; means for annotating the displayed web-page and means for saving the web projects, the web-pages and the annotations on the server.

### CROSS-REFERENCE TO RELATED PATENT APPLICATIONS

This patent application claims priority from and is related to U.S. Provisional Patent Application Ser. No. 61/045,639, filed on 17 Apr. 2008, this U.S. Provisional Patent Application incorporated by reference in its entirety herein.

### TECHNOLOGICAL FIELD

The invention relates to methods, systems and computer program products for management, personalizing and sharing of web content.

### BACKGROUND

Web applications have been in use for years. Typically, websites and web applications are comprised of different technologies, such as html pages, ASP documents, Java, .NET, etc.

The main shortcomings of conventional websites, web-browsers and web applications are that they do not allow comfortable management of the web content one consumes, nor do they enable a real synergy between edited web content and user generated content on the internet. Users are, for the most part, limited in their “online experience” to the capabilities provided by the website editor. These shortcomings can be defined in five main categories:
1) Existing web-browsing applications (IE, Firefox, etc.) do not allow users to efficiently manage their online content according to their own selective and personalized preferences.
2) Existing web-browsing applications do not enable users to easily annotate, customize or share their online experience with others.
3) User generated content cannot easily be distributed over any website on the internet and is subject to website functionalities and editing limitations.
4) Existing web-based communication tools (Email, IM, VOIP) do not allow users to automatically share their visited-sites path and reflect their personal online experience and insight to designated others.
5) Existing social-web-communities (BeBo, MySpace, Facebook, Friendster, . . . ) enable their members to interact solely within the framework of the community and its pre-selected articles/contents. Users cannot share surfing sequences from outside of the site they are on.

While the existing web applications may be suitable for the particular purpose which they address, they are not as suitable for internet users who wish to manage their web content in their web browser and express themselves to any user on any website, regardless of the website's functionality or editorial censorship and restrictions. Neither are the existing solutions suitable for the smartening web surfer, who wishes to manage, customize and personalize his/her surfing experience to match their needs.

### SUMMARY

A computerized system and method for managing, sharing and annotating web pages. The system comprises a system server including a server application and a www server communicating over the internet with one or more client computers.

Each client computer comprises a www browser and a client application.

The system server stores, for each client computer, a plurality of web-projects folders, each folder comprising links to web-pages accessed by the client computer's user, annotations added by the user to the web-pages and permissions granted by the user to other client application users to view at least part of the stored information,

The server application comprises means for managing said stored data,

Each client application comprises means for viewing the stored server data, means for managing the stored server data, means for selecting a web project, means for selecting a web-page for display, means for annotating the displayed web-page, means for saving the web projects, the web-pages and the annotations on the server and means for sharing the stored server data with other users.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic general block diagram of the system enabling the invention;

FIGS. 2A through 2C are block diagram of the system components;

FIG. 3 is a schematic block diagram of the server's main database;

FIG. 4 is a flowchart showing various exemplary steps taken by the client application;

FIGS. 5A through 5G show various features of an exemplary GUI for the client application;

FIG. 6 is a flowchart describing an exemplary use case of the client application;

FIG. 7 is a flowchart showing the steps performed by the user to add a new Web-Project;

FIG. 8 is a flowchart showing the steps performed by the user to add a new R_Page to a Web-Project;

FIG. 9 is a flowchart showing the steps performed by the user to add an annotation to an R_Page;

FIG. 10 is a flowchart showing the steps performed by the user for managing WPs and WPs' attributes;

FIG. 11 is a flowchart showing the steps performed by users other than the WP's creator for managing R_Pages in the WP;

FIG. 12 is a flowchart showing the steps performed by the user for managing a WP's Buddy list;

FIG. 13A is a flowchart showing the steps performed by the user for managing a WP's lo Buddy list;

FIG. 13B is a flowchart showing the steps performed by a registered application user who has been selected by a WP creator as a Buddy to be granted sharing permission;

FIG. 13C is a flowchart showing the steps performed by a user not registered to the application who has been selected by a WP creator as a Buddy to be granted sharing permission;

FIG. 14 is a flowchart showing the steps performed by the user for sharing a WP he has created with groups of friends and for managing the groups; and

FIG. 15 is a flowchart showing the steps performed by the user for sharing a WP he has created with other persons who are not in his lists of buddies, friends or groups.

### DETAILED DESCRIPTION OF PREFERRED EMBODIMENTS

Methods, systems and computer readable products for management, personalization and sharing of web content are provided. The computer program product can include a computer readable medium that stores instructions that once executed by a computer, cause the computer to perform the various stages of the application as described below.

It is noted that the method and system may execute any combination of the stages described.

The application brings forth an innovative surfing experience, enabling both simple and high-end users to easily express themselves and interact with others.

The application is meant to allow all internet users to:
a. Manage—make your browser a smarter place for keeping track of all the web content you consume. Stack and order the pages and elements you access on the web for further use and reference.
b. Discover—Experience the internet according to personal preferences and habits, discover new content relevant to your fields on interest, turning your browser into a sophisticated search and discovery device.
c. Personalize—Convey any message on any internet website, regardless of the site's comment (“talkback”) policy, using advanced graphical tools.
d. Share—Communicate with any or all internet users in a more realistic manner, based on mutual online-presence and interest similarity, rather than on a deliberate purpose/goal-oriented basis.

The application brings together two worlds—that of traditional internet content and that of user-generated content (UGC);
The system allows users to manage (upload, post, share, etc.) content of any kind and format on top of existing content, using a layer mechanism that corresponds with an existing graphical layout. Content can be managed in a simple and intuitive manner, serving the user's needs and personal preferences.
The system manages content, comments, users, personal and multi-user communication, and enables searching, sorting, filtering, parsing, synchronization, content redesign and the like, over any existing media (web, text, video, audio, image, IPTV, etc.) and on any technology (www, OS, applications, networking etc.).
The system allows a user to inosculate any type of user content (texts, drawings, pictures, videos, etc . . . ), of any format (.doc, .txt, .png, .jpg, . . . ) with any online content presented on his/her browser with proximately precise location capabilities on the original content, and seamlessly presents the renovated web content to other internet users by means of any internet browser.

The system achieves the goals mentioned below:
Intuitive access to and management of content consumed on the web
A real synergy between UGC and managed content on the internet, by means of a platform for opinion sharing and comment posting on any website, independent of website functionalities.
Making UGC significantly more accessible and manageable, enabling all users to both sound their personal voice and hear others'. Every corner of the web is accessible to comment and personalization: news site, social community sites, dating sites, e-commerce sites, blog sites, any site! Content can easily be managed and categorized, according to the user's needs and preferences, thereby allowing him/her to access the content they are most interested in and that is most relevant to them. Web-content can thus be utilized rather than just consumed.
Enabling users to express themselves, in every web site, including the ability to communicate & interact with other users in the same web site. Providing a platform for personal and filtered interaction with focused, content oriented audiences, bringing together the talkback and IM arenas;
   The application allows the user interact with web users of similar interests in a casual and natural manner, e.g. approach someone subsequent to a comment they posted on a website, share the experience of a soccer match watched alone in a hotel room with fellow fans, etc.
   On the other hand—The application allows the users to spend their online time only with people they like, immune to interaction and inputs from any unwanted users.
   The application makes the entire web a social network and serves as a very powerful social tool.
Enabling visualization and personalization of personal add-on content
   The application turns every webpage into the user's own personal drawing board.
   The application allows users to post their comments anywhere on a webpage. Using a smart and simple drag-and-drop grid, the application users can post their comments and remarks anywhere on a webpage, rather than be restricted to a conventional comment table layout.
Audience segmentation—the application enables user segmentation, based on personal characteristics as well user habits.
Targeted Marketing—User Type—the application enables targeting different audiences, addressing specific user types, with adapted content tailored to the user's interests.
Targeted Marketing—Surfing Habits and location based advertising—the application enables placing targeted ads and content in specific locations on the original content, according to the user's surfing habits and tendencies.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The following terms used throughout the description are meant to convey the following interpretation:

Web Project (WP)—The WP is the parent element in the client application. It logically resembles a folder on your computer or a shelf in a library and facilitates accumulation of web-based content, i.e. web pages and optionally other documents in any format.

There are two types of Web Projects in the application—a user initiated WP and a content promotion WP, initiated by an external user of the application (e.g. system administrator, content manager).

R_Page—A web-page URL or any type of document stored by the user in a WP and uploaded to the server.

Annotation (comment)—User Generated Content (UGC) added by a user to an R_Page. Annotations are stored in WPs, linked to the appropriate R_page.

Annotation Layer—An annotation layer is a logical viewing element to which all annotation elements added to a certain web page are attributed, subject to various filters such as annotation date, annotation type, etc.

User—A private or institutional Internet user who has the user application.

Super User—a user of the application with extended permissions and capabilities.

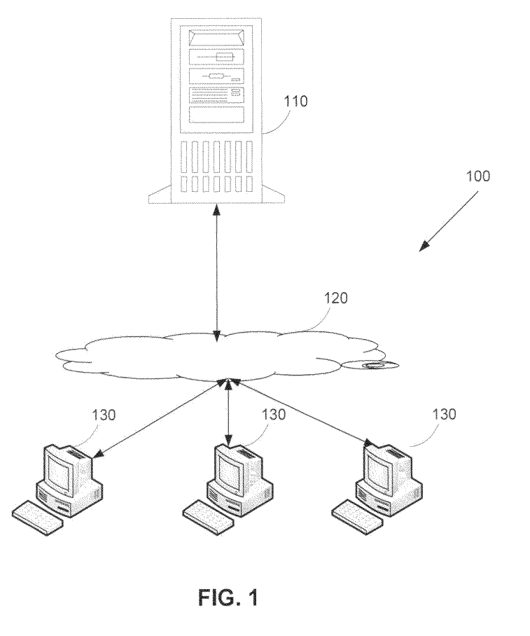

FIG. 1 is a schematic general block diagram of the system (100) enabling the invention, comprising a system server (110) communicating with client computers (130) over the internet (120).

Each client computer comprises a client application, downloaded from the server (110) to the client (user) computer (130) upon registering to the service. The client application is a web pages management tool, comprising GUI tools that enable annotating, sharing and managing selected web pages. The client application may be implemented as an add-on to the client's browser, or as an independent application (e.g. MSN messenger, ICQ, etc.).

The server comprises a server application that manages folder hierarchies, communicates folder contents to the client application and stores new or updated folders and folder content communicated by the client application. The server application also manages users, permissions and files.

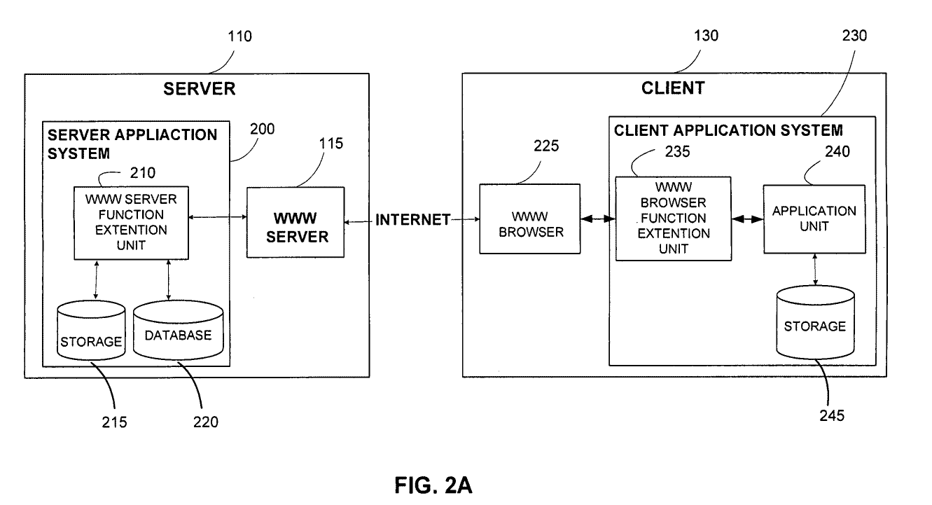

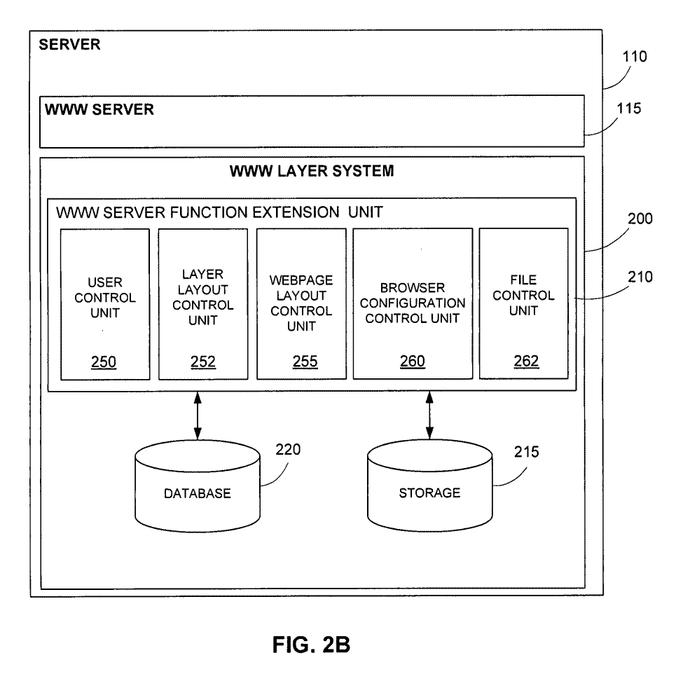

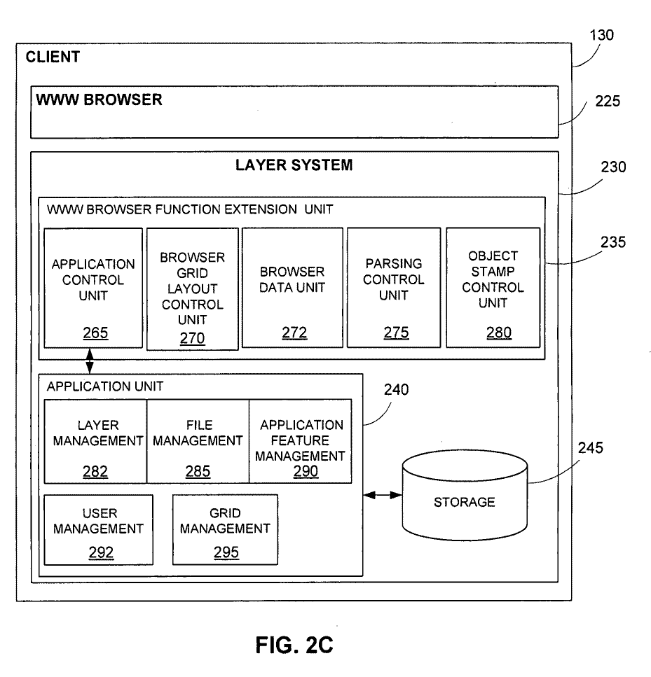

FIGS. 2A through 2C are schematic block diagrams detailing the various system parts according to the present invention.

FIG. 2A is a general block diagram of the entire system, comprising:
The server (110), which includes a www server (115) and a server application system (200), comprising a www server function extension unit (210), communicating bi-directionally with a storage device (215) and with a database (220);
The client (130), which includes a www browser (225) and a client application system (230) comprising a www browser function extension unit (235) communicating bi-directionally with an application unit (240), the application unit (240) communicating bi-directionally with a storage device (245).

FIG. 2B is a block diagram providing a detailed view of the server's www server function extension unit (210), comprising the following modules:
User control unit (250), which manages user tables and permissions;
Layer layout control unit (252), which manages the annotations metadata;
Webpage layout control unit (255), which manages the web projects, pages and annotations in a hierarchical order;
Browser configuration control unit (260), which allows for customization of the GUI;
File control unit (262), which manages annotation files (pictures, audio, video, text files).

The server application may also serve as a business tool, by:
Keeping track and cross statistical parameters on the commentators and their comments that are an indication of surfers' needs and opinions. Such information can later serve for marketing and advertisement needs.
Tailing the amount of users responding to online content as opposed to the amount of responses/comments posted.
Allowing users to consume content and advertisement most relevant to their needs and interests, based on surfing history enhanced with commenting details (where in a page has a user commented? On which specific content? Picture, text, etc.).
Enabling targeted advertisement according to user preferences as well as according to user surfing habits, including precise placement of ads based on user commenting history.
Enabling advertisers to receive information on user surfing habits and areas of interest within a specific content, in real time (immediately upon content publishing).

FIG. 2C is a block diagram providing a detailed view of the client www browser function extension unit (235) and the application unit (240).

The client www browser function extension unit (235) serves as proxy between the browser and the client. It is implemented according to the MVC (Model, View, Controller) architecture and comprises the following modules:
Application control unit (265), which supplies the communication between the browser function extension unit (235) and the application unit (240);
Browser grid data control unit (270), which creates html elements (e.g. DIV containers for bubble elements, highlighted text, etc.) and runs Java Scripts;
Browser data unit (272), which receives browser events and passes them to the application control unit (265) on demand;
Parsing control unit (275), which comprises a pointer to the DOM and maps the html elements;
Object stamp control unit (280), which performs hashing on DOM elements, using, for example, MD5 hashing.

The application unit (240) comprises all the application components and features and includes the following modules:
Layer management module (282)—manages the user interface, e.g. transparent win-form and other UI controls;
File management module (285)—manages the application's persistent storage, comprising registry and file system, and manages registry access and file manipulations;
Application feature management module (290)—the code behind the user interface, handles all the operations clicked by the user;
User management module (292)—manages login components, user authentication and session id;
Grid management module (295)—the engine that prepares the page for mapping and annotations' insertion by JavaScript injection.

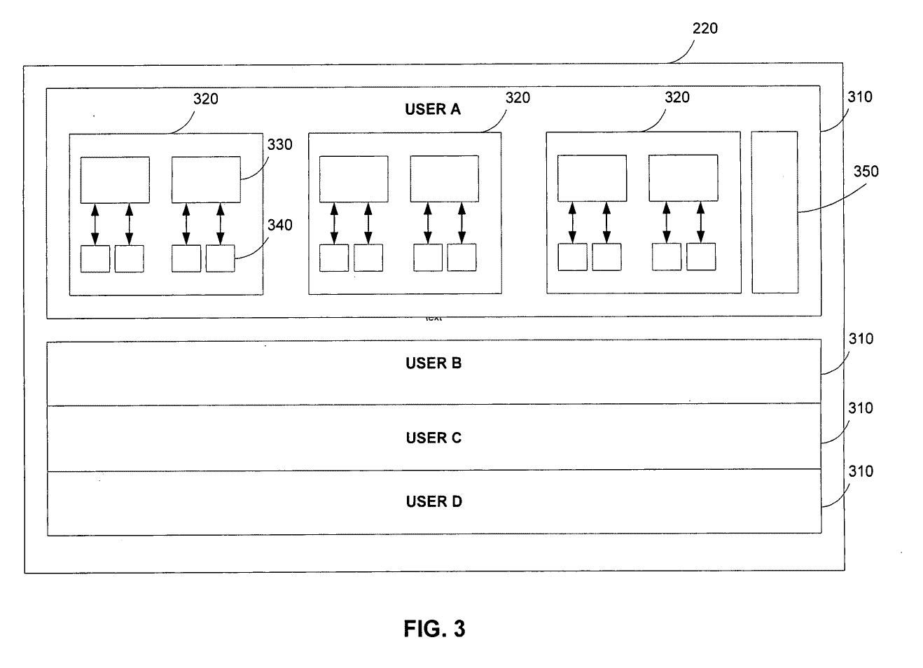

FIG. 3 is a schematic block diagram of the server (110) main database (220), storing a plurality of user folders (310), each comprising one or more web-project folders (320). Each web-project holds one or more R_Pages (330) saved by the user, where each R_Page is optionally connected with one or more UGC containers (340), storing content added by the user to the R_Page. The content is represented by the type of container (bubble, video, audio, etc), the shape, color, X and Y positioning on the webpage (preliminary default parameters), content instance (the element hash relative to other elements), width, height of the shape and a hash element generated on the client side while positioning the annotations to DOM elements. Each user folder may additionally comprise a “friends” list (350), from which the user may select for granting permissions to view, update or delete web projects (320), R_Pages (330) within web projects, or UGC containers (340) within web projects.

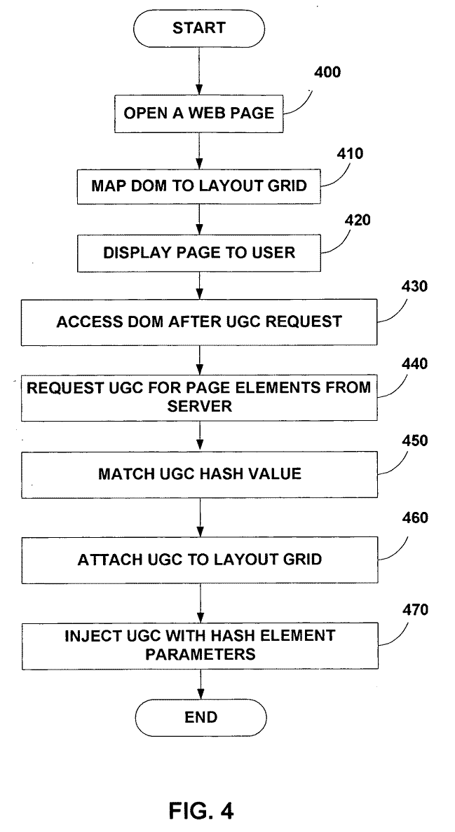

FIG. 4 is a flowchart showing the various steps taken by the client application following a user's request for a web page from one of the web projects to be displayed by the application unit (240), provided the client application is active.

In step (400), the layer management module (282) fires a navigation event to the application feature management module (290). The www browser extension unit (235) receives the navigation request for the client side browser data unit (272), which executes it, i.e. the document (web page) is downloaded.

In step (410) the document object model (DOM) is accessed, the grid management module (295), as part of the browser function extension unit (235), sends a request to the browser grid layout control (270), to creates a DIV container <div> in the DOM below the <body> html tag and a JavaScript <script></script> below the <HEAD> html tag, as a preparation for injecting the annotation and files that were received from the server. The JavaScript includes several scripts that manipulate the DOM as part of the user requests (element position, hashing (MD5), hovering effect, element data, html element, highlight text ,PageScanThread, pageResizeThread, PageManagement, PageMergeThread, Utils). The browser grid layout control (270) sends a DOM “Mirror” request to the parsing control unit (275) mapping the DOM elements, and another request to the object stamp control unit (280) to calculate the hash value for the DOM elements.

The page is subsequently displayed to the user (step 420). The DOM is accessed again (step 430). The DOM now includes DIV containers inserted by the browser grid layout unit (270) as part of the JavaScript functionality that was described above and enable the JavaScript injection for each UGC added to the page, which optionally enables attachment of the UGC to a specific page element according to the hashing that was calculated before.

In step (440) the application unit (240) fires a GET request over http to the server (110) for available annotations for the R_page in the web project that was chosen, as stored in the database hierarchy (FIG. 3). The server's www layer system (200) transfers the request to the webpage layout control unit (255) and the layer layout control unit (252) and retrieves the annotation details (type, shape, color, X, Y, content instance, width, height, element hash, etc.) from the database (220). Another request is transferred to the server's file control unit (262) that retrieves any additional files (audio, video, text, etc.) from the storage (215) back to the application unit (240).

In step (450) a hash value is matched for the UGC that was retrieved in step (440); the browser grid layout control unit (270) uses the element hash JavaScript to match the hash value of the elements (using, for example, MD5 hashing).

In step (460) the annotations and files are attached to DOM elements on the grid layout; the layer management module (282) fires an event to the www browser function extension unit (235) that receives an ‘add UGC’ to the browser grid layout control unit (270), which creates an html annotation object in a DIV container according to the annotation and files retrieved in step (440).

In step (470) the application unit (240) sends a JavaScript injection request to the browser function extension unit (235). The JavaScript injects the DIV container to the DOM element according to the hash element found on the page and the hash element that was retrieved in step (440) for each UGC.

The client application has a GUI, displayed whenever a user opens a browser instance/window, or upon specific request, as a transparent overlay over the viewed web page, in a manner that does not hinder any regular operation. The application appears as part of the browser window on the one hand, but floats on top of the browsed content on the other.

Client features are brought to the user in the form of a toolbar (or any other GUI design) and a layer grid, as part of the browser functionality or the OS.

The GUI comprises four main tools' categories:
Viewing tools;
Annotation tools;
Management tools;
Sharing tools; and
Search tools.

I. Viewing Tools

The viewing tools may comprise, but are not limited to:

Add/delete/Update Layer

A user will be able to add a layer to a certain webpage, including the following:
Choosing the presented identity (a user's identity will not have to be disclosed)
Choosing the content element (bubble, voice, video, etc.)
Drag-and-drop placement of the content element
Content editing (text/voice/paint/video)
Layer approval
After submitting, a user can retrieve his/her layers and delete them.

Adding a layer to a webpage will allow an application user to post his/her comment (of all types) to any active webpage and share their content with other application users. Layers added by application users will be accessible to other application users, under filtering restraints.

View Layer

View the application's user-added layers to any existing webpage. For every active webpage, the application user will be able to view UGC layers created for the webpage by himself and other application users, which are stored on the application server. Once activated, all the application layers are visible per webpage, subject to filter and publication permissions.

While viewing the application layers to a webpage, the user can modify the following parameters:
number of layers shown simultaneously
filtering

Rank

The application enables ranking of layers, users, comments and comment elements. All ranking will be added to the user's general grading as well as for other statistical purposes.

Block

Blocking options are available for comment types, specific users, layer date, etc.

Disable Layer View

Disabling the layer view will allow a user to surf the internet without seeing the application layers that have been added by application users to each page he/she visits. The application features will still be accessible to the user.

Filter

A user can filter the users/layer types/comment types he/she views via the application.

Every application user will be able to view the application layers according to personal preferences and filtering and in accordance with the authorization granted to the layer but its creator. Filtering tools in the application enable a user to view layers of a certain type, layers from certain users, layers from certain entry dates, layers for certain websites, etc.

The application's filtering tools also enable users to converse with each other on an authorized-only basis.

Navigate Between Annotations in Layer

A user will be able to navigate between different annotations in any layer randomly, time-based, filtered, etc.
Navigate between layers

A user will be able to navigate between comments added by different users to the same URL.

II. Annotation Tools

The Annotation tools may comprise, but are not limited to:
Select comment type (e.g. bubble comment, regular text comment, picture, video file, audio file, animated comment, etc.).

Add Comment

A user may initiate a new thread of content on a new layer or reply to an existing layer of content displayed on a certain webpage.
Initiating a new comment to a new layer will entail adding a layer to the page.
Adding a new comment to an existing layer can be done in one of the following ways:
   If the layer in question was initiated by the user, he/she can access the layer's content (once identified) and both edit existing comments and/or add new ones.
   If the layer in question was initiated by another user, the user can add a comment to the layer only if the layer's permissions (set by its creator) allow it.
Replying to a comment
   A user may reply to any content element on any layer as long as the layer permissions allow it.
   A reply to an existing comment will be linked to the comment it is replying to and displayed adjacent to it.
   If several replies are posted to the same comment, these will be displayed in rotation on the layer.
Placing a comment
   A comment (and a reply) will be placed on the application layer using Drag and Drop technology.
   Placement of a comment will be made according to the layer's grid.
A comment (and a reply) may be linked to elements (text/pictures/banners) on the webpage.

Edit Comment

A user may edit his/her comments only.

III. Management Tools

The Management tools may comprise, but are not limited to:
New—open a new, empty, web-project.
Attributes—change the web-project's name, add tag words to the web-project, add a description, date, format, etc.
Add page—add an R_Page to a web-project (either current URL from browser, or saved URL from My Favorites or History or other location on the user's computer, or any type of document).
Delete (WP/R Page)—deleting a web-project will disable access to the WP via the application and the website. All connections and permissions configured for the WP will be eliminated.
Show/Open page of a WP in the Browser.
Indicate (WP/R_Page)—provide a visual indication of chances performed by other users to a WP and/or its R_Pages.
Set Schedule—set an alarm and/or an automated action to a WP or an R_Page, prompting one of, but not limited to, the possible actions below:
   Activate a WP indicators at a certain time or under a certain set of circumstances;
   Load a certain R_Page to the browser (instead of the user's default homepage, or in a new tab) on a certain date and time and/or repeatedly.

IV. Sharing Tools

The Sharing tools allow the user to configure access through the application to a WP/page/annotation (by other users). By limiting access permission to a small group of users, or to one user, the sharing option may provide an alternative tool for relaying personal messages. The sharing tools may comprise, but are not limited to:
Sharing a WP/R_Page/annotation in the application by allowing access to the RP/WP to different users, as chosen by the WP initiator.
Permission management—the initiator of a WP can manage and control the access granted to other users to the WP and its contents. Access can be granted on different levels, from complete admin access (like the owner and initiator of the WP/RP) to selective annotating options (e.g. text and not video). The initiator of the WP may revoke such access granted at any point.
Sharing a WP in a different format (html, pdf, ppt, . . . ), for users who do not have the application. In this case the application will automatically generate a presentation (in any of the above mentioned formats) of all the pages in a WP. This presentation will be placed in a public/private area of the application website and will be accessible to other internet users. Such a presentation can also be embedded in other websites.
Promotional WP—promotional WPs are created by super users via the application or via a dedicated web-interface. The user will not be able to modify the information provided in the promotional WP but will be able to share it with his/her friends. The user will also be able to annotate the content within the promotional WP, just like a regular WP. The owner of a promotional WP will be able to grant access to the WP to all the users of the application according to a predefined set of filters and criteria:
   According to a user's web-location—specific ads, recommendations, tips, etc., based on the user's visited site;
   According to a user's profile details—recommendations and content promotions based on the user's age, gender, preferences, etc.;
   According to a certain date/time—prompting of offers limited in time, promotion of time-dependent content (meal deals, end-of-year deals, seasonal deals, etc.)
Examples of promotional WPs:
   A recommendation Web-Project of a bank—This WP is managed by a representative of the bank and responds to either the user's whereabouts on the web—content is promoted automatically, based on the sites the user visits, or the application manager's content base—content is promoted to the user regardless of their online activity, and is triggered solely by the application manager. The recommendation WP will provide the user with relevant financial tips on saving money and managing one's cash flow subsequent to the site the user is visiting and/or the content that is due to be promoted;
   A Helper WP—initiated by the application manager and consisting of explanations about the application—the Helper WP will be accessible to all users and provide information on how to use the application.

V. Search Tools

The application enables users and system managers to search an organized comment database for comments by specific web site topic, layers, users, time frame etc.

Layers can be searched by:
Layer creator
Number of elements on a layer
Layer type (should there be any)
Layer date
Etc.

Users can be searched by:
Layer
Personal info
A user will be able to keep track of his/her comments posted on different websites at different timestamps.

Further searches can be made on:
Web Project (public, promotional)
Elements
Comments on elements of a certain type
Similar objects that have been commented
Etc.

All the searches above, when run on the server database, may be used by the application administrator for statistical purposes and may help generate advertisement requirements by mapping user behavior.

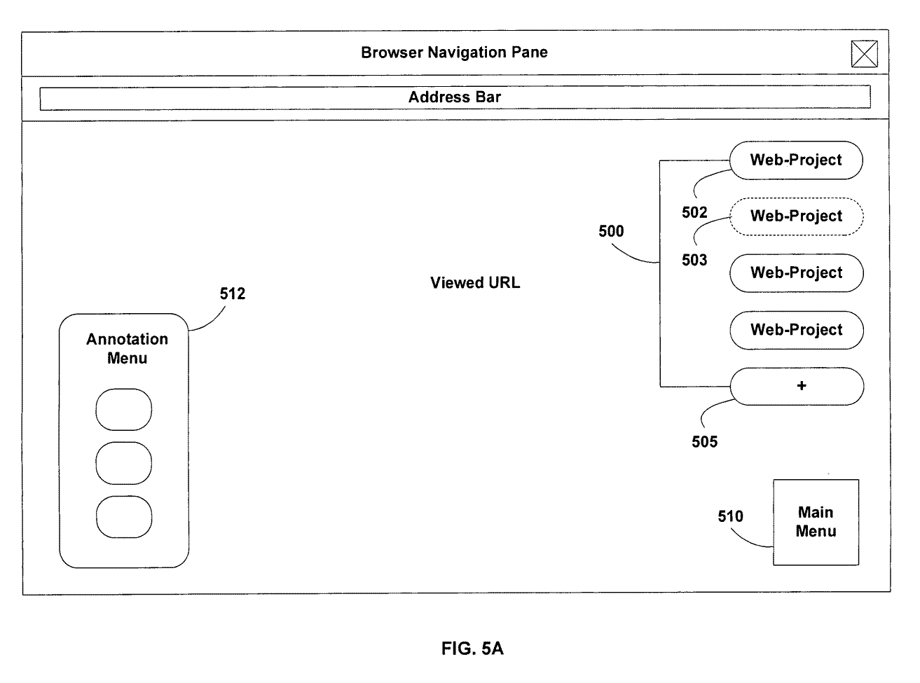

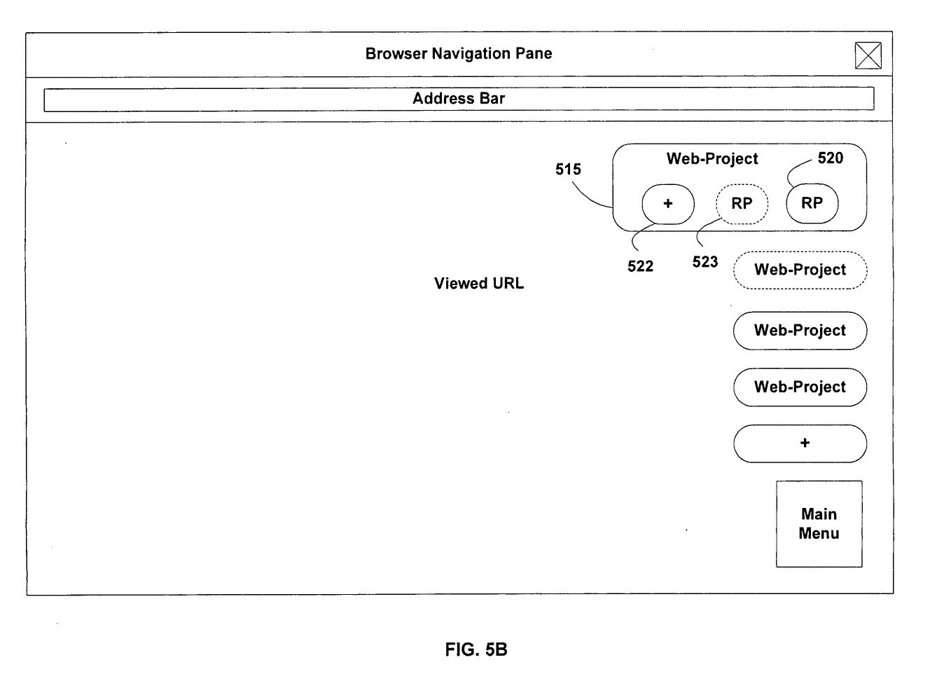

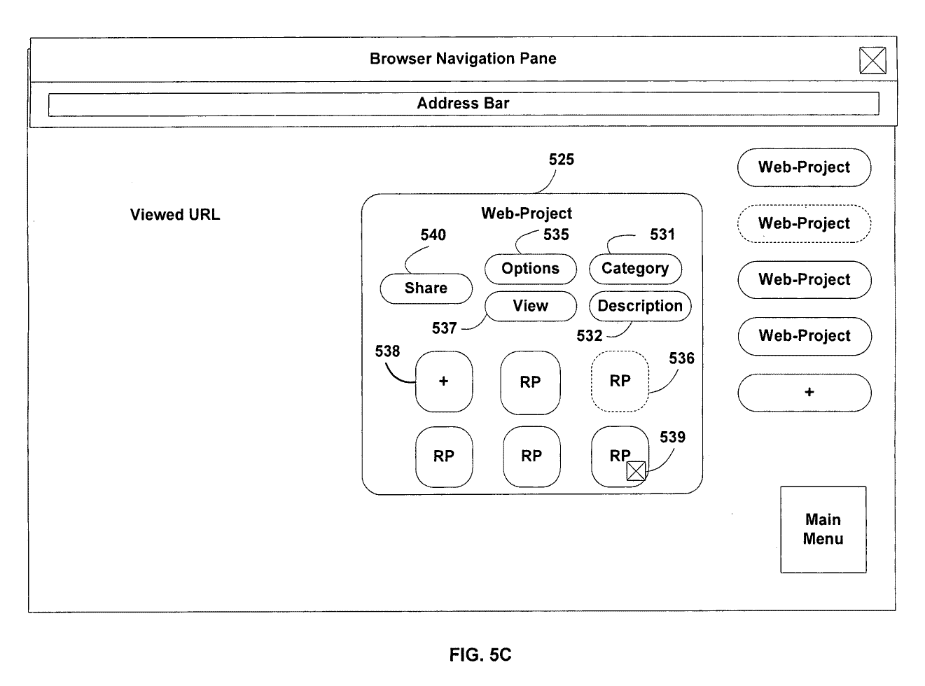

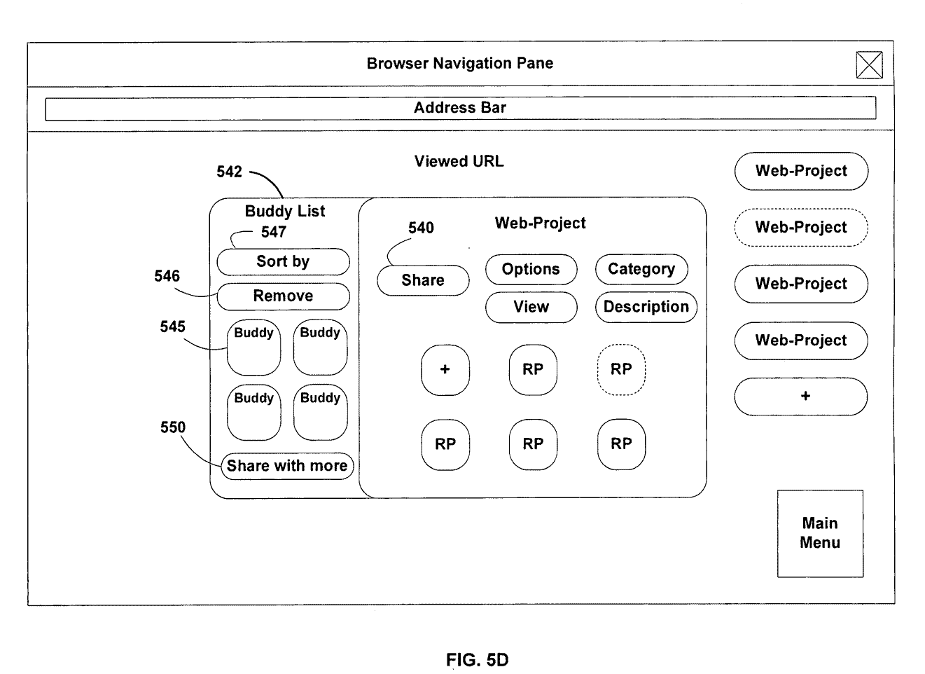

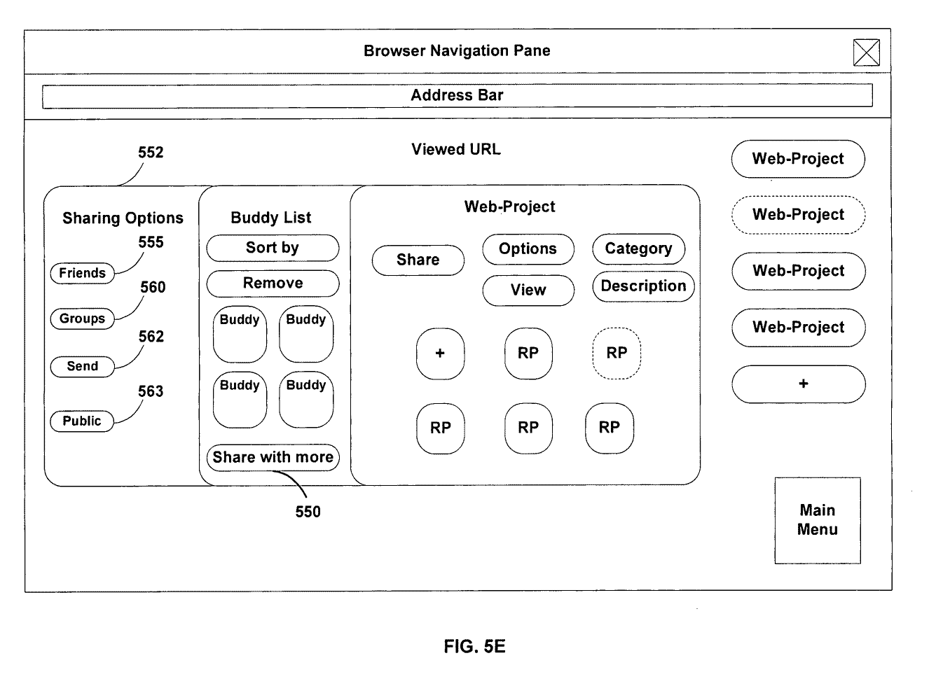

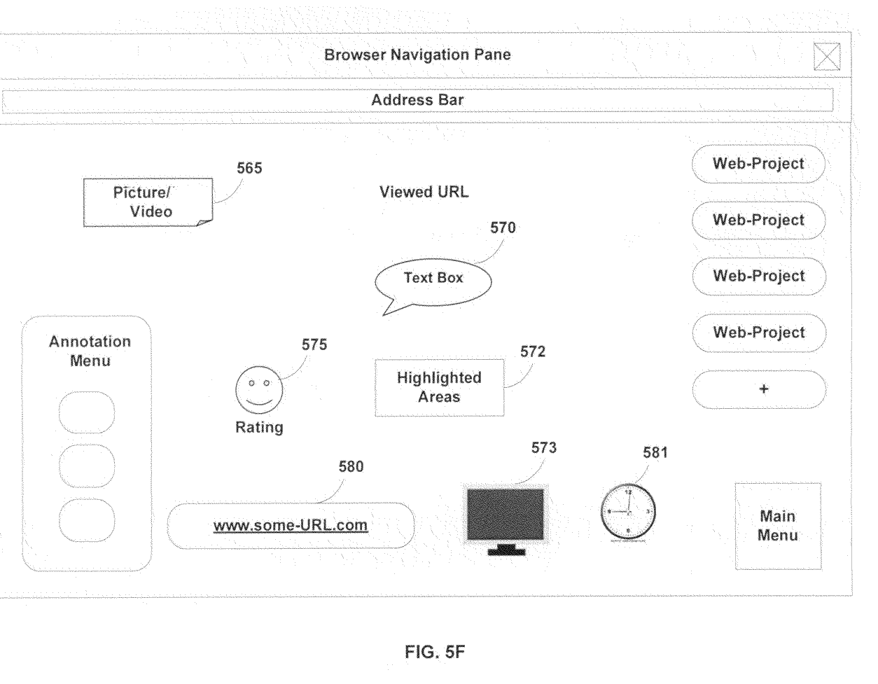

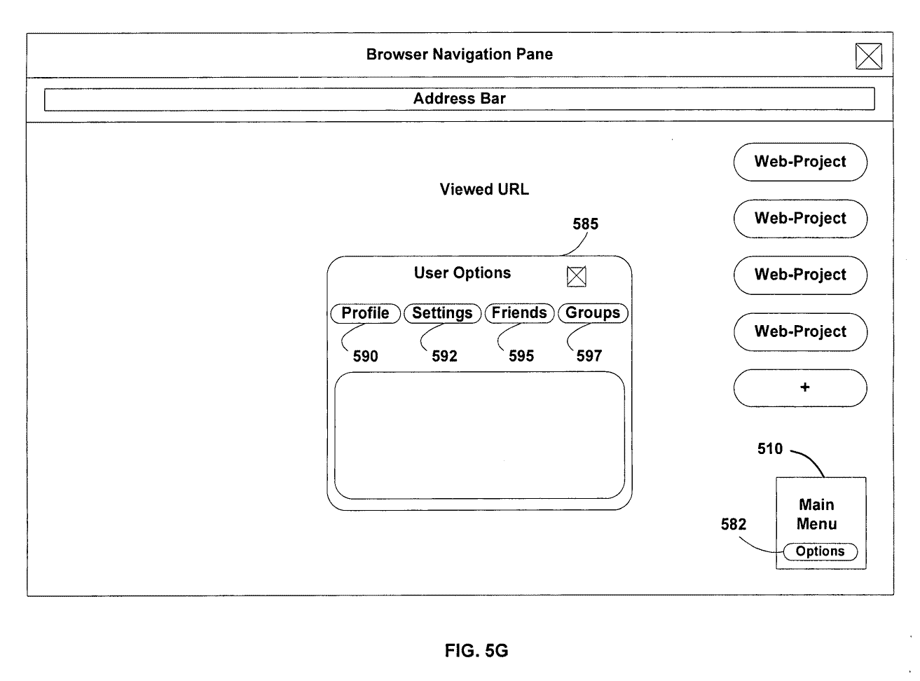

FIGS. 5A through 5G show various features of an exemplary GUI for the client application.

FIG. 5A shows an exemplary first GUI screen comprising a web-projects list display (500) providing a small size display of each web-project (502) and an empty web-project (505) with a “+” button for creating a new web-project. Each web-project may indicate changes performed to the web-project, e.g. added R_Pages, by other authorized users, since it was last viewed. The change indication may be in the form of e.g. blinking or color indication, and is shown in FIG. 5A as a dashed frame (503). The screen additionally comprises the application's main menu (510) and an annotation menu (512) comprising various annotation type choices.

FIG. 5B shows a web-project (515) selected to be viewed in medium size display. The web-project medium size display shows thumbnails of the R_Pages within the web-project (520) and an empty R_Page (522) with a “+” button for creating a new R_Page in the web-project. Each R_Page may indicate changes performed to the R_Page, e.g. added annotations, by other authorized users, since it was last viewed. The change indication may be in the form of e.g. blinking or color indication, and is shown in FIG. 5B as a dashed frame (523).

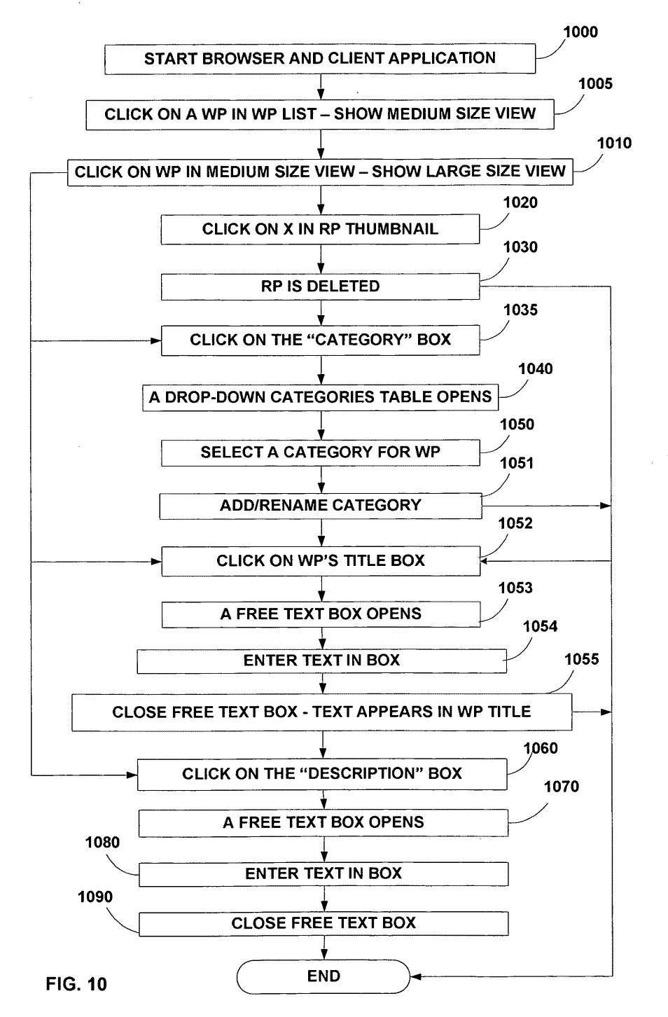

Additional indications may exist, such as but not limited to: “Your WP has been shared with . . . ”, an R_Page is no longer viewable”, “A URL of an R_Page is unreachable”, etc. FIG. 5C shows a web-project (525) selected to be viewed in large size display. The large-size display shows, on top of the medium size display, the web-project's “Category” (531) and “Description” (532) button, an “Options” button (535), a “View” button (537) and a “Share” button (540), as will be explained in detail in conjunction with FIGS. 10 through 12.

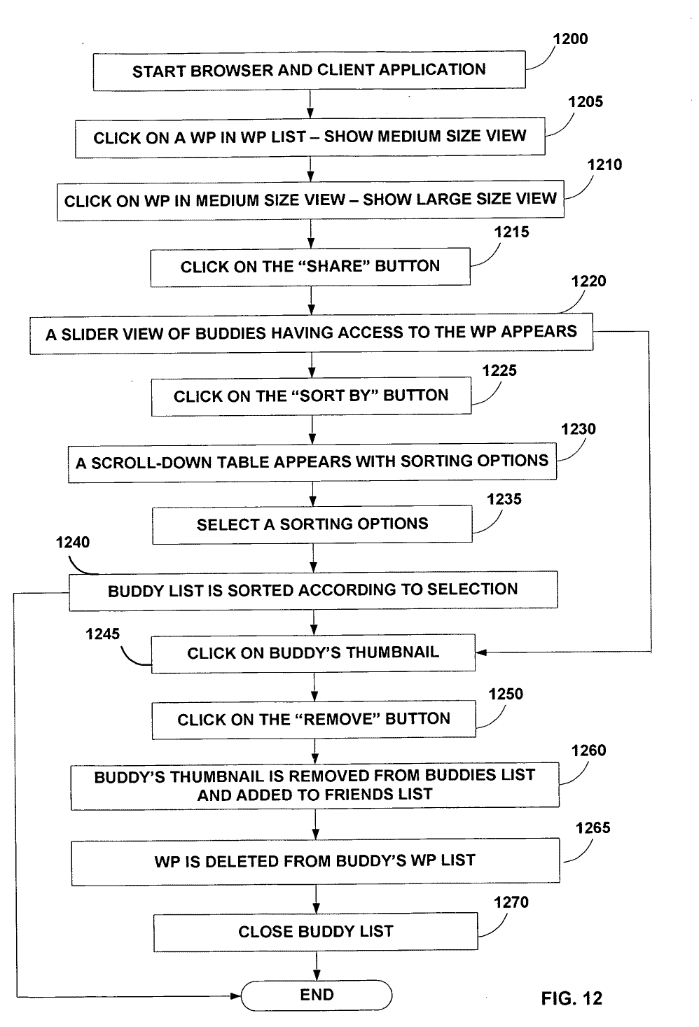

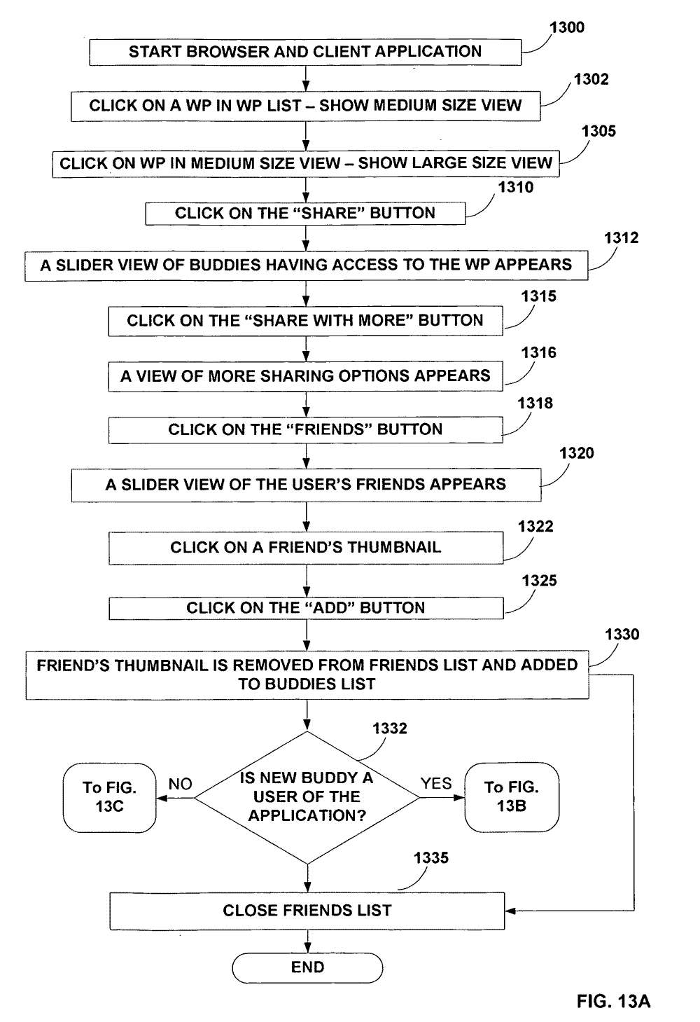

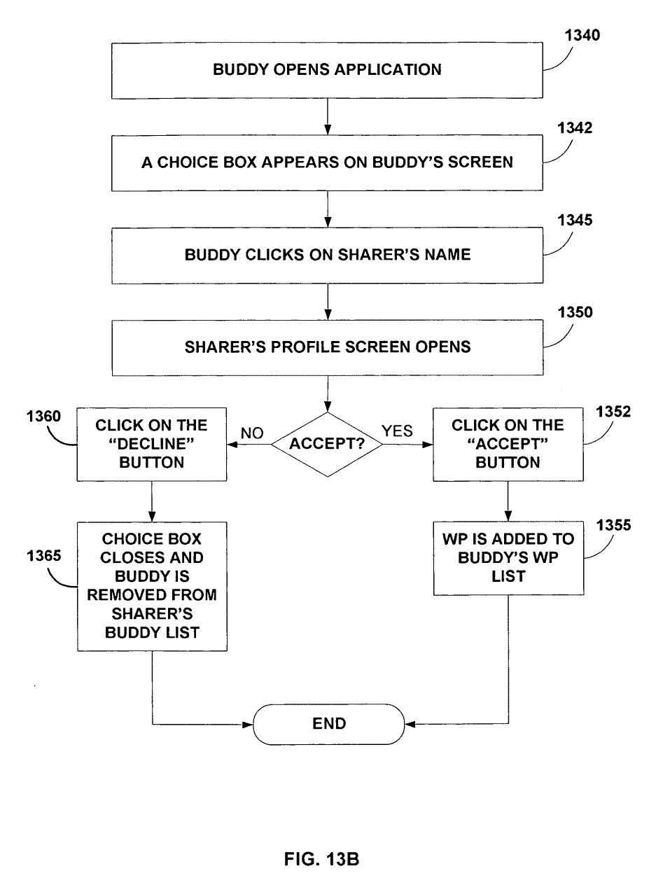

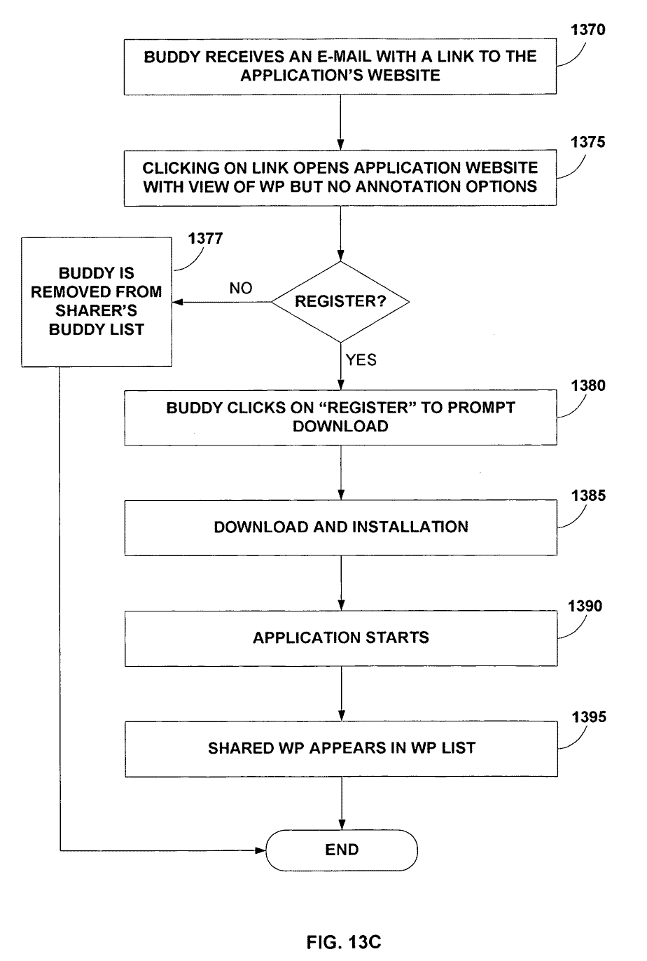

FIG. 5D shows an exemplary “Buddy List” (542) GUI implementation, which opens when the user has pushed the “Share” button (540). The “Buddy List” (542) may comprise a list of users having access to the web-project and optionally thumbnails (545) of the buddies. The “Share with more” button (550) may be used to grant various access permissions to the web-project as explained in conjunction with FIG. 5E and as will be explained in detail in conjunction with FIGS. 13 through 15. The “Sort by” button (547) may be used to sort the buddy's list, as will be explained in detail in conjunction with FIG. 12. The “Remove” button (546) may be used to remove buddies from the “Buddy List”, as will be explained in detail in conjunction with FIG. 12.

FIG. 5E shows an exemplary “Sharing Options” (552) GUI implementation, which opens when the user has pushed the “Share with more” button (550). The “Sharing Options” (552) may comprise “Friends” (555), which is the default options for viewing the “Buddy List”, “Groups” (560), for viewing groups of users to share the web-project with, “Send” (562) for other sharing possibilities such as sharing via a link, e-mail, etc., as will be explained in detail in conjunction with FIGS. 13 through 15 and “Public” (563) for publishing the web-project or a web-page over the internet, to a designated site. The site may be the application website, or any other website. The publishing may be implemented via iframe, flash container, or any other designated container for displaying a minimized version of an R_Page or a web-project on another website. A link to every R_Page and web-project on the server's database will be automatically created for carrying out this option.

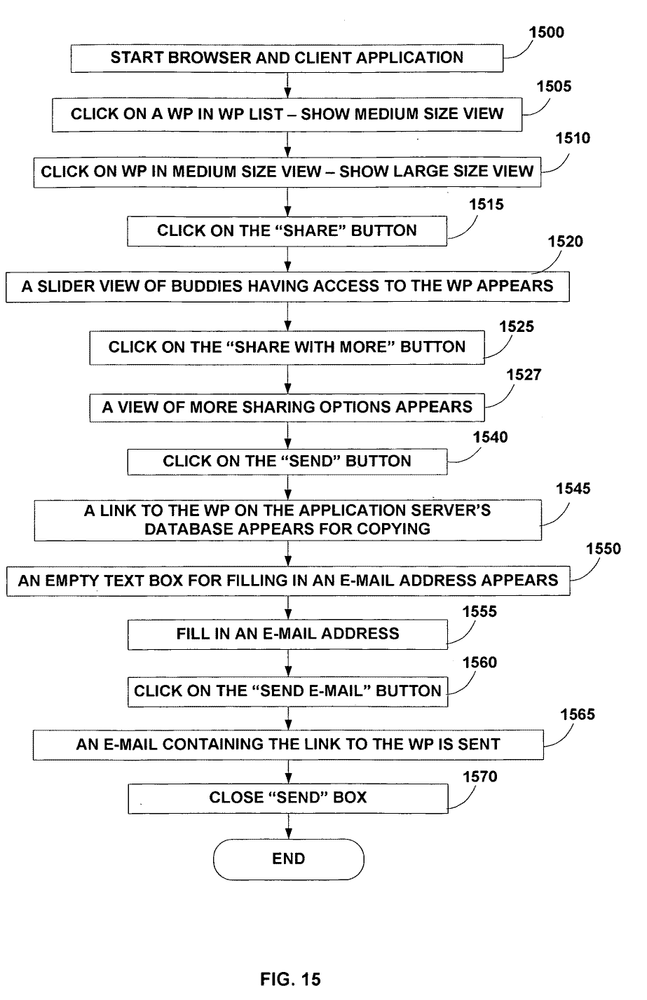

FIG. 5F shows an example of various annotation options layered on the annotation layer of the viewed web-page. The exemplary annotation options comprise adding a picture or video (565), adding as text bubble (570), highlighting areas of the viewed web-page (572), rating the viewed web-page (575) and adding a URL of the WP to the application website (580), as will be explained in detail in conjunction with FIG. 15. The annotations layer may additionally comprise a timer (581) for indicating recurring times in which the R_Page will be automatically displayed, e.g. on every 5^{th} day of a month, or conditions for automatically displaying the R_Page, e.g. annotations have been added to the R_Page in any of the WPs including it, by any user. The annotations layer may additionally comprise a screen saving tool (573), requesting that the currently viewed R_Page will be saved as a screen capture, including areas obscured from the current display due to the page's size. The saving tool (573) is designed to save pages that may change in time in their current form.

FIG. 5G shows an exemplary “User Options” GUI implementation, which opens when the user has pushed the “Options” button (582) on the main menu (510). The “User Options” window (585) comprises various administrative options such as “Profile” (590) for setting profile options (privacy settings, profile picture, personal details), “Settings” (592) for viewing options of the web-projects' list and web-projects, “Friends” (595) for management of the friends' list (allocating friends to groups, adding or deleting friends from list) and “Groups” (597) for management of groups (adding or deleting groups, adding or deleting group members).

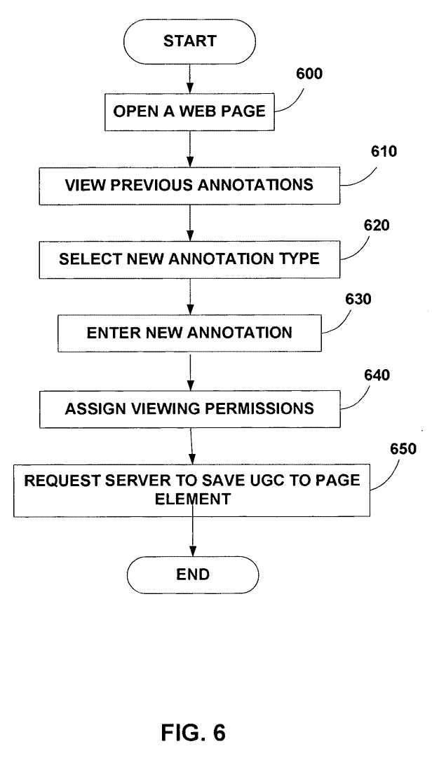

FIG. 6 is a flowchart describing an exemplary use case of the client application. In the example of FIG. 6, the client application is active and the user wishes to add an annotation to a web page.

In step (600), the user opens a web page. The web page may be selected from any one of the web-projects displayed by the GUI.

In step (610) the user may view previous annotations attached to the viewed page by himself, or by other users that have permitted the specific user or all users to view their annotations. In this step the user may navigate between various annotations attached to the page.

In step (620) the user selects the desired annotation type to be added, e.g. bubble text comment, video file, audio file, animated comment, etc. The new annotation may reflect a new idea or reflection of the user regarding the web page content, or it may be a response or comment relating to a previous user's annotation.

When the user adds a UGC to the page using the GUI, the layer management (282) fires an event to the application feature management (290), following which the application unit (240) transfers the request to the application control unit (265) that fires a new DIV Container event to the browser grid layout control unit (270). The browser grid layout control unit (270) creates the HTML and injects it to the DOM with the JavaScript engine.

In step (630) the user enters the new annotation, according to the annotation type selected in step (620).

The layer management (282) fires a new edit event to the application feature management (290) and enables writing text, adding files and recording video/audio using the file management (285).

In step (640) the user assigns viewing permissions to the new annotation, using the user management module (292). The permission assignment is done by selecting user names from the “friends” list, or by permitting any user to view the new annotation. Alternatively or additionally, the user may search users to be granted permission on the server, or he may enter an e-mail address of a user that is not in the system.

In step (650), the application unit (240) fires a GET request over http to the server (110) for saving annotations of the R_page in the Web project that was chosen, as stored in the database hierarchy (FIG. 3). The www layer system (200) transfers the request to the server side layer layout control unit (252) and saves the annotation details (Type, Shape, Color, X, Y, Content instance, width, height, element hash, etc) from the database (220). Another request is transferred to the server side file control unit (262) that saves any additional files (audio, video, text, etc.) and permissions on the server side user control unit (250). The data is saved on the database (220) and files are stored in the storage (215). A “successfully saved” message is retrieved back to the application unit (240).

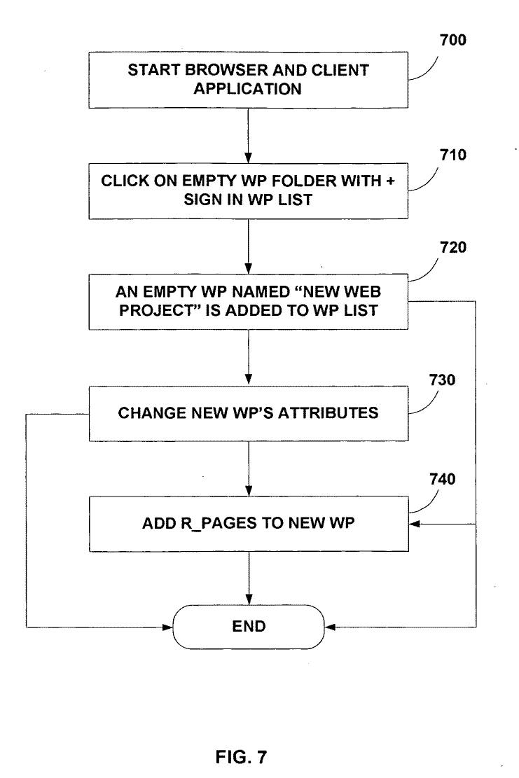

FIGS. 7 through 15 show various exemplary operations performed by the application users, using the GUI components described in conjunction with FIGS. 5A through 5G.

FIG. 7 is a flowchart showing the steps performed by the user to add a new Web-Project. In step (700) the browser is opened and the client application starts (either automatically or by request). In step (710) the user clicks on an empty folder having the “+” sign (505) in the WP list, which causes an empty WP named “New Web-Project” to be added to the WP list (step 720). In step (730) the user may change the default attributes of the new WP, i.e. category and description, sharing options etc. and in step (740) the user starts adding R-Pages to the newly created WP.

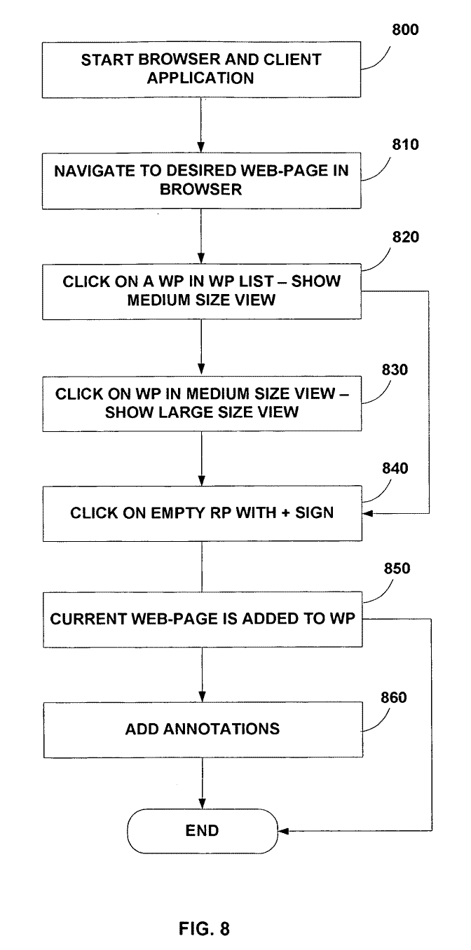

FIG. 8 is a flowchart showing the steps performed by the user to add a new R_Page to a Web-Project. In step (800) the browser is opened and the client application starts (either automatically or by request). In step (810) the user navigates to a web-page in the browser. In step (820) the user clicks on one of the WPs in the displayed WPs list, which causes the selected WP to be displayed in a medium size display (515). The user may proceed to click on the medium size display (step 830) to view a large size display of the selected WP (525). In step (840) the user clicks on an empty R_page with a “+” sign (538), whereby the currently viewed web-page is added to the WP. The user may now add annotations to the new R_Page (step 860).

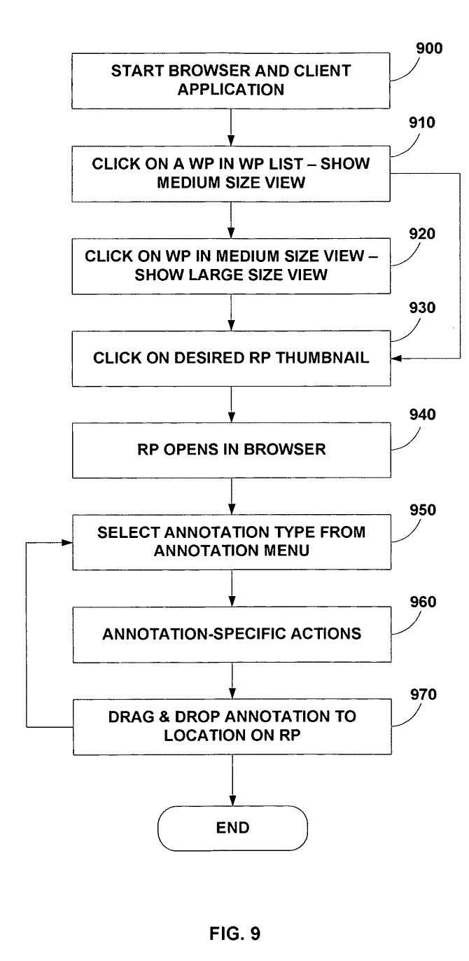

FIG. 9 is a flowchart showing the steps performed by the user to add an annotation to an R_Page. In step (900) the browser is opened and the client application starts (either automatically or by request). In step (910) the user clicks on one of the WPs in the displayed WPs list, which causes the selected WP to be displayed in a medium size display (515). The user may proceed to click on the medium size display (step 920) to view a large size display of the selected WP (525). In step (930) the user clicks on the R_page to be annotated, which causes the selected R_Page to be displayed in the browser (step 940). In step (950) the user selects a desired annotation type from the annotation menu (512) and then proceeds to enter the annotation, e.g. enter text in a text box, upload a video file, etc. (step 960). In step (970) the user drags & drops the newly created annotation to the desired location on the R_Page.

FIG. 10 is a flowchart showing the steps performed by the user for managing WPs and WPs' attributes. Steps (1000-1010) are similar to steps (900-920) of FIG. 9.

If the user wishes to delete an R_Page from the viewed WP, he clicks on the X (539) in the R_Page's thumbnail (step 1020) and the R_Page is deleted from the WP (step 1030).

In step (1035) the user clicks the “Category” box (531), which causes a categories table to be displayed (step 1040). The user may now select a category for the WP from the list (step 1050), and add a new category to the list or rename a category (step 1051).

If the user wishes to rename a WP, he clicks on the WP's title box (step 1052), whereby a free text box opens (step 1053) and the user enters the new WP title thereto (step 1054). The new title now appears in the WP's title box (step 1055).

In step (1060) the user clicks the “Description” box (532), which causes a free text box to open (step 1070). The user may now enter free text to describe the WP (step 1080). In step (1090) the user closes the free text box, optionally by clicking outside its perimeter and the text appears in the description box of the WP.

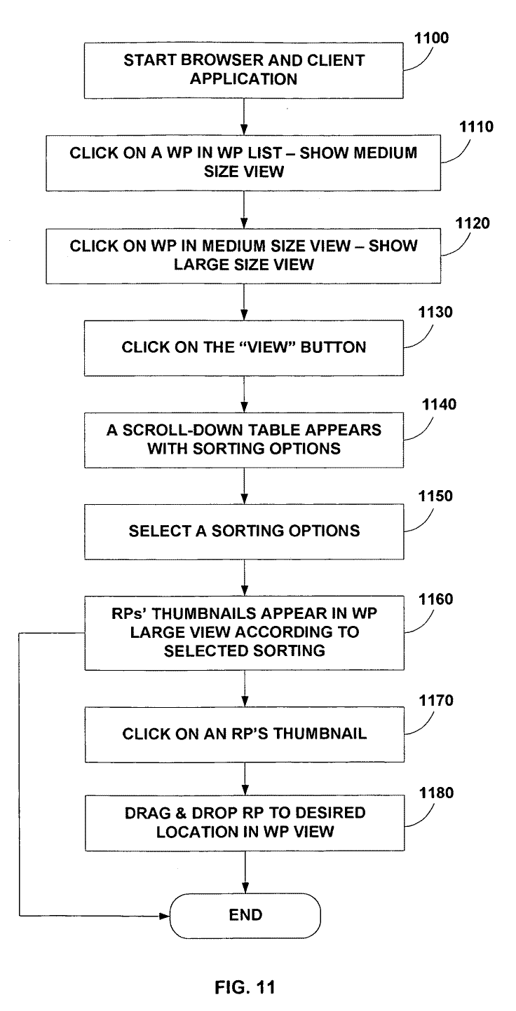

FIG. 11 is a flowchart showing the steps performed by users other than the WP's creator for managing R_Pages in the WP. Steps (1100-1120) are similar to steps (900-920) of FIG. 9. In step (1130) the user clicks the “View” button (537) in the WP's large display (525), which causes various sorting options to be displayed (step 1140), optionally as a scroll-down menu. The user proceeds to select a sorting option (step 1150), e.g. by date, by alphabetic order of R_pages names, by first annotation date, etc. In step (1160) the R_Pages' thumbnails (536) are displayed according to the selected sorting criterion. Additionally or alternatively, the user may reorder R_pages' view in the large size WP display by selecting an R_Page (step 1170) and dragging & dropping it to its desired location (step 1180).

FIG. 12 is a flowchart showing the steps performed by the user for managing a WP's Buddy list. Steps (1200-1210) are similar to steps (900-920) of FIG. 9. In step (1215) the user clicks the “Share” button (540), which causes a list of all buddies having access permission to the viewed WP to be displayed (step 1220), optionally as a slider view.

If the user wishes to sort the list, he my push the “Sort by” button (547) (step 1225), whereby a list of sorting options is displayed (step 1230), optionally as a scroll-down table. The sorting options may comprise sorting by name, by date of sharing the WP, by last activity in WP, etc. The user proceeds to select a sorting option from the displayed list (step 1235), whereby the buddies list is sorted accordingly (step 1240).

If the user wishes to remove a buddy from the buddies list, he may click on the buddy's thumbnail (545) (step 1245), then click on the “Remove” button (546) (step 1250). The buddy's thumbnail is subsequently removed from the Buddies list and added to the Friends list (555) (step 1260). In step (1265) the WP is deleted from the WP list of the removed buddy and in step (1270) the Buddies list is closed.

FIG. 13A is a flowchart showing the steps performed by the user for sharing a WP he has created with other users. Steps (1300-1312) are similar to steps (1200-1220) of FIG. 12. In step (1315) the user clicks the “Share with more” button (550), which opens a view of additional sharing options (552) (step 1316). The user then clicks on the s “Friends” button (555) (step 1318), which causes a list of all the user's Friends to the viewed WP to be displayed (step 1320), optionally as a slider view. In step (1322) the user clicks on one of the friends' thumbnails and then on the “Add” button (step 1325), which causes the selected friend's thumbnail to be removed from the Friends list and added to the Buddies list (542) (step 1330). The application may visually indicate which friends and buddies are registered users of the application. The indication may, for example, comprise a different color of the thumbnail's frame. In step (1332) the application checks whether the new buddy is a user of the application and the server application acts accordingly (FIGS. 13B and 13C). In step (1335) the Friends list is closed.

FIG. 13B is a flowchart showing the steps performed by a registered application user who has been selected by a WP creator as a Buddy to be granted sharing permission. In step (1340) the user opens the client application, which causes a choice box to be opened on his screen, including one or more WP creator names (step 1342). In step (1345) the user clicks on one of the sharer names, whereby the sharer's profile is displayed (step 1350). If the user chooses to accept the offered sharing, he clicks on the “Accept” button (step 1352), which causes the shared WP to appear on his WPs list (step 1355). Otherwise, the user may click the “Decline” button (step 1360), whereby the choice box closes and the user is removed from the sharer's Buddy list (step 1365).

FIG. 13C is a flowchart showing the steps performed by a user not registered to the application, who has been selected by a WP creator as a Buddy to be granted sharing permission. In step (1370) the buddy receives an e-mail comprising a link to the application website. In step (1375) the user clicks on the link, which causes the shared WP to be displayed without annotation options. The buddy may now choose to become a registered user of the application, in which case he clicks the “Register” button (step 1380). In step (1385) the application is downloaded and installed on the buddy's computer and in step (1390) the application starts, with the shared WP appearing in the buddy's WPs list (step 1395). If the buddy elects not to register to the application, he is removed from the sharer's Buddy list (step 1377).

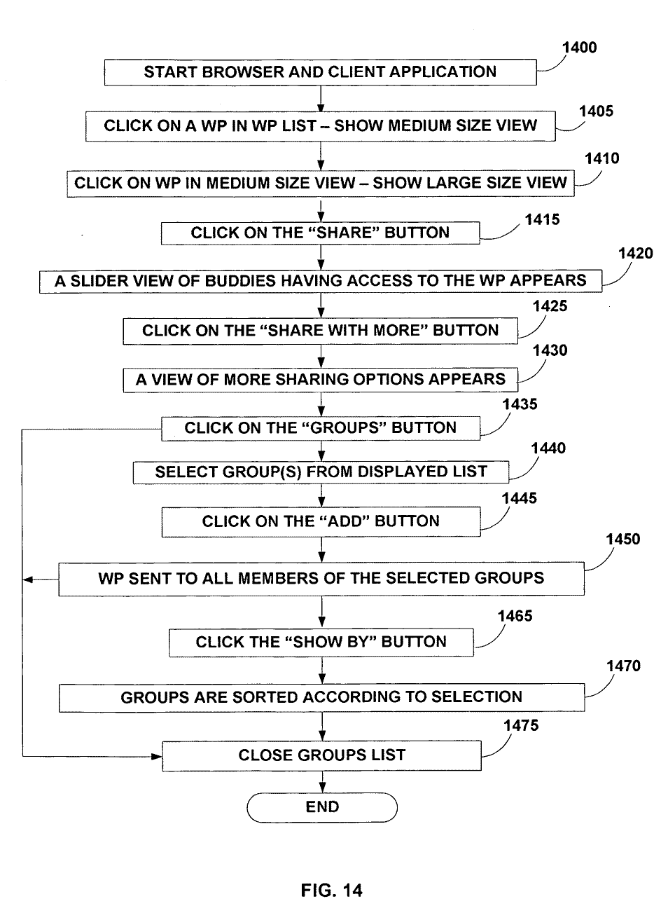

FIG. 14 is a flowchart showing the steps performed by the user for sharing a WP he has created with groups of friends and for managing the groups. Steps (1400-1430) are similar to steps (1300-1316) of FIG. 13A. In step (1435) the user clicks on the “Groups” button (560), whereby a list of all available groups is displayed.

If the user wishes to share the current WP with a certain group's members, he may select a group (step 1440) and click on the “Add” button (step 1445), whereby the WP will be sent to all the selected group's members (step 1450), as described in detail in conjunction with FIGS. 13B-13C.

If the user wishes to sort the groups, he may click the “Show by” button (step 1465). A list of sorting options will be displayed, from which the user may choose a sorting option (e.g. sort alphabetically by group name). The groups will be sorted accordingly (step 1470). In step (1475) the “Groups” list is closed.

FIG. 15 is a flowchart showing the steps performed by the user for sharing a WP he has created with other persons who are not in his lists of buddies, friends or groups. Steps (1500-1527) are similar to steps (1300-1316) of FIG. 13A. In step (1540) the user clicks the “Send” button (562), causing a link to the WP on the application server's database (580) (step 1545) and an empty text box (step 1550) to be displayed. In step (1555) the user fills in the recipient's e-mail address and clicks on “Send e-mail” (step 1560), which causes an e-mail containing the link to the WP to be sent (step 1565). In step (1570) the “Send” box is closed.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof which would occur to persons skilled in the art upon reading the foregoing description.

1. A computerized system for managing, annotating and sharing web pages comprising:
a system server comprising a server application and a www server, the system server communicating over the internet with one or more client computers, each comprising a www browser and a client application,
said system server storing, for each said client computers, a plurality of web-project folders, each web-project comprising links to web-pages accessed by said client computer's user and annotations added by said user to said web-pages,
said server application comprising means for managing said stored data,
each said client applications comprising means for viewing said stored server data; means for managing said stored server data; means for selecting a web project; means for selecting a web-page for display; means for selecting an annotation for display; means for annotating said displayed web-page and means for saving said web projects, said web-pages and said annotations on the server.

2. The system of claim 1, wherein said system server additionally stores permissions granted by said user to other persons to at least one of view and update at least part of said stored information and wherein said client application additionally comprises means for sharing said stored server data with other persons.

3. The system of claim 2, additionally comprising GUI means for indicating one of a changed web-project and a changed web-page within a web-project.

4. The system of claim 1, additionally comprising means for automatically displaying a web-page according to predefined criteria.

5. The system of claim 2, additionally comprising means for automatically displaying a web-page according to predefined criteria.

6. The system of claim 4, wherein said predefined criteria are time dependent.

7. The system of claim 5, wherein said predefined criteria are time dependent.

8. The system of claim 1, additionally comprising means for capturing entire screens of displayed web-pages, said screen captures stored in said web-projects on said web server.

9. The system of claim 2, additionally comprising means for capturing entire screens of displayed web-pages, said screen captures stored in said web-projects on said web server.

10. The system of claim 1, wherein each said web projects additionally comprises attributes, said attributes selected from the group consisting of: title, date, category and description.

11. The system of claim 2, wherein each said web projects additionally comprises attributes, said attributes selected from the group consisting of: title, date, category and description.

12. The system of claim 10, wherein said title, category and description are editable.

13. The system of claim 11, wherein said title, category and description are editable.

14. The system of claim 2, wherein said web-projects comprise sharing options.

15. The system of claim 14, wherein said sharing options are selected from the group consisting of: single persons, groups of persons and publishing to websites.

16. The system of claim 15, wherein at least one of said persons is not a user of the application.

17. The system of claim 16, wherein said sharing options comprise means for sending an e-mail to said at least one person, said e-mail comprising a link to the application server's database.

18. The system of claim 15, wherein said publishing to websites comprises means for saving links to web-projects and web-pages on the server and means for embedding said links in websites.

19. The system of claim 1, wherein said means for viewing said stored server data comprise GUI means for displaying said web-projects, said web-pages within each web-project and said annotations.

20. The system of claim 2, wherein said means for viewing said stored server data comprise GUI means for displaying said web-projects, said web-pages within each web-project and said annotations.

21. The system of claim 19, wherein said GUI means comprise a transparent overlay over the viewed web page.

22. The system of claim 20, wherein said GUI means comprise a transparent overlay over the viewed web page.

23. The system of claim 20, wherein said means for viewing said web-projects comprises means for indicating a web-project changed by another user.

24. The system of claim 19, wherein said means for viewing the web-project comprise means for selecting a display size, each said selectable display sizes comprising a different level of details.

25. The system of claim 20, wherein said means for viewing the web-project comprise means for selecting a display size, each said selectable display sizes comprising a different level of details.

26. The system of claim 1, wherein said client application's means for managing said stored server data comprise GUI means for manipulating said displayed web-projects, said means for manipulating selected from the group consisting of: adding/deleting a web-project and adding/deleting a page to/from a web-project.

27. The system of claim 2, wherein said client application's means for managing said stored server data comprise GUI means for manipulating said displayed web-projects folders, said means for manipulating are selected from the group consisting of: adding/deleting a web-project, adding/deleting a page to/from a web-project and adding/deleting viewing permissions to a web-project member.

28. The system of claim 1, wherein said means for annotating comprise means for selecting an annotation type and means for inserting an annotation according to the selected type.

29. The system of claim 2, wherein said means for annotating comprise means for selecting an annotation type and means for inserting an annotation according to the selected type.

30. The system of claim 28, wherein said annotation type is selected from the group consisting of: bubble text comment, highlighted text, picture, video file, audio file and animated comment.

31. The system of claim 29, wherein said annotation type is selected from the group consisting of: bubble text comment, highlighted text, picture, video file, audio file and animated comment.

32. The system of claim 1, wherein said means for annotating comprise drag-and-drop means.

33. The system of claim 2, wherein said means for annotating comprise drag-and-drop means.

34. The system of claim 1, wherein said means for annotating comprise means for inserting html elements into the displayed web-page DOM by running a JavaScript on the DOM.

35. The system of claim 2, wherein said means for annotating comprise means for inserting html elements into the displayed web-page DOM by running a JavaScript on the DOM.

36. The system of claim 1, wherein said means for saving said web-pages and said annotations on the server comprise means for uploading the web-projects to the server.

37. The system of claim 2, wherein said means for saving said web-pages and said annotations on the server comprise means for uploading the web-projects to the server.

38. The system of claim 2, wherein said means for sharing comprise means for granting at least one of viewing and update permissions.

39. The system of claim 38, wherein said viewing and update permissions are granted to at least one of a web-project, a web-page and an annotation.

40. The system of claim 1, wherein said server application comprises means for mapping user behavior, said means comprising statistical tools applied to the stored server data.

41. The system of claim 2, wherein said server application comprises means for mapping user behavior, said means comprising statistical tools applied to the stored server data.

42. The system of claim 2, wherein at least one web-project is shared with all the client application users, according to predefined criteria, said web-project created by a super-user.

43. The system of claim 42, wherein said predefined criteria are selected from the group consisting of: user's web-location, user's profile details, date and time.

44. A computerized method for managing, annotating and sharing web pages comprising:
storing on a server, for at least one client computer, a plurality of web-project folders, each web-project comprising links to web-pages accessed by said client computer's user and annotations added by said user to said web-pages;
managing said stored data;
downloading a client application to said at least one client computer;
downloading said stored data to said at least one client computer;
viewing said downloaded data on said at least one client computer;
managing said viewed data on said at least one client computer;
selecting a web project from said viewed data;
selecting a web-page for display from said selected web project;
annotating said displayed web-page; and
saving said web projects, said web-pages and said annotations on the server.

45. The method of claim 44, additionally comprising storing on said server permissions granted by said user to other persons to at least one of view and update at least part of said stored information and sharing said stored server data with other persons.

46. The method of claim 45, additionally comprising indicating one of a changed web-project and a changed web-page within a web-project.

47. The method of claim 44, additionally comprising automatically displaying a web-page according to predefined criteria.

48. The method of claim 45, additionally comprising automatically displaying a web-page according to predefined criteria.

49. The method of claim 47, wherein said predefined criteria are time-dependent.

50. The method of claim 48, wherein said predefined criteria are time-dependent.

51. The method of claim 44, wherein viewing said downloaded data comprises viewing said web-projects, said web-pages within each folder and said annotations.

52. The method of claim 45, wherein viewing said downloaded data comprises viewing said web-projects, said web-pages within each folder and said annotations.

53. The method of claim 51, wherein viewing said web-projects comprises selecting a display size, each said selectable display sizes comprising a different level of details.

54. The method of claim 52, wherein viewing said web-projects comprises selecting a display size, each said selectable display sizes comprising a different level of details.

55. The method of claim 44, wherein each said web projects additionally comprises attributes, said attributes selected from the group consisting of: title, date, category and description.

56. The method of claim 45, wherein each said web projects additionally comprises attributes, said attributes selected from the group consisting of: title, date, category and description.

57. The method of claim 55, wherein managing the viewed data comprises editing at least one of said title, category and description.

58. The method of claim 56, wherein managing the viewed data comprises editing at least one of said title, category and description.

59. The method of claim 45, wherein each said web-projects comprises sharing options.

60. The method of claim 59, wherein said sharing options are selected from the group consisting of: single persons, groups of persons and publishing to websites.

61. The method of claim 60, wherein said publishing to websites comprises saving links to web-projects and web-pages on the server and embedding said links in said websites.

62. The method of claim 60, wherein at least one of said persons is not a user of the application.

63. The method of claim 62, wherein sharing said stored server data comprises sending an e-mail to said at least one person, said e-mail comprising a link to the application server's database.

64. The method of claim 44, wherein said managing the viewed data comprises at least one of adding/deleting a web-project and adding/deleting a page to/from a web-project.

65. The method of claim 45, wherein said managing the viewed data comprises at least one of adding/deleting a web-project and adding/deleting a page to/from a web-project and adding/deleting viewing permissions to a web-project member.

66. The method of claim 44, wherein said annotating comprises selecting an annotation type and inserting an annotation according to the selected type.

67. The method of claim 45, wherein said annotating comprises selecting an annotation type and inserting an annotation according to the selected type.

68. The method of claim 66 wherein said annotation type is selected from the group consisting of: bubble comment, regular text comment, highlighted text, picture, video file, audio file and animated comment.

69. The method of claim 67 wherein said annotation type is selected from the group consisting of: bubble comment, regular text comment, highlighted text, picture, video file, audio file and animated comment.

70. The method of claim 66, wherein said annotating comprises dragging and dropping the annotation to its location on the displayed web-page.

71. The method of claim 67, wherein said annotating comprises dragging and dropping the annotation to its location on the displayed web-page.

72. The method of claim 44, wherein said annotating comprise inserting html elements into the displayed web-page DOM by running a JavaScript On the DOM.

73. The method of claim 45, wherein said annotating comprise inserting html elements into the displayed web-page DOM by running a JavaScript On the DOM.

74. The method of claim 44, wherein said saving the web-pages and the annotations on the server comprises uploading the web-projects to the server.

75. The method of claim 45, wherein said sharing comprises granting at least one of viewing and update permissions.

76. The method of claim 75, wherein said viewing and update permissions are granted to at least one of a web-project, a web-page and an annotation.

77. The method of claim 44, additionally comprising the step of mapping user behavior.

78. The method of claim 45, additionally comprising the step of mapping user behavior.

79. The method of claim 77, wherein said mapping user behavior comprises applying statistical tools to the stored server data.

80. The method of claim 78, wherein said mapping user behavior comprises applying statistical tools to the stored server data.

81. The method of claim 45, wherein at least one web-project is shared with all the client application users, according to predefined criteria, said web-project created by a super-user.

82. The method of claim 81, wherein said predefined criteria are selected from the group consisting of: user's web-location, user's profile details, date and time.
